(19) United States
(12) Patent Application Publication
(10) Pub. No.: US 2024/0155289 A1
(43) Pub. Date: May 9, 2024

(54) CONTEXT AWARE SOUNDSCAPE CONTROL

(71) Applicant: Dolby Laboratories Licensing Corporation, San Francisco, CA (US)

(72) Inventors: Zhiwei SHUANG, Beijing (CN); Yuanxing MA, Beijing (CN); Yang LIU, Beijing (CN)

(73) Assignee: Dolby Laboratories Licensing Corporation, San Francisco, CA (US)

(21) Appl. No.: 18/548,791

(22) PCT Filed: Apr. 28, 2022
(86) PCT No.: PCT/US2022/026828

§ 371 Date: Sep. 1, 2023

Related U.S. Application Data
(60) Provisional application No. 63/197,588, filed on Jun. 7, 2021.
(60) Provisional application No. 63/195,576, filed on Jun. 1, 2021.

(30) Foreign Application Priority Data
Apr. 29, 2021 (WO) PCT/CN2021/090959
May 12, 2021 (WO) PCT/CN2021/093401

(51) Int. Cl. H04R 3/00; G10L 21/0216; H04R 1/10; H04S 7/00

(52) U.S. Cl. CPC H04R 3/005; G10L 21/0216; H04R 1/1091; H04S 7/304; H04R 1/1016; H04R 2420/01; H04R 2499/11

(57) ABSTRACT

Embodiments are disclosed for context aware soundscape control. In an embodiment, an audio processing method comprises: capturing, using a first set of microphones on a mobile device, a first audio signal from an audio scene; capturing, using a second set of microphones on a pair of earbuds, a second audio signal from the audio scene; capturing, using a camera on the mobile device, a video signal from a video scene; generating, with at least one processor, a processed audio signal from the first audio signal and the second audio signal, the processed audio signal generated with adaptive soundscape control based on context information; and combining, with the at least one processor, the processed audio signal and the captured video signal as multimedia output.

### CROSS-REFERENCE TO RELATED APPLICATIONS

This application claims the benefit of priority from U.S. Provisional Patent Application No. 63/197,588, filed on Jun. 7, 2021, U.S. Provisional Patent Application No. 63/195,576, filed on Jun. 1, 2021, International Application No. PCT/CN2021/093401, filed on May 12, 2021, and International Application No. PCT/CN2021/090959, filed on Apr. 29, 2021, which are hereby incorporated by reference.

### TECHNICAL FIELD

This disclosure relates generally to audio signal processing, and more particularly to user-generated content (UGC) creation and playback.

### BACKGROUND

UGC is typically created by consumers and can include any form of content (e.g., images, videos, text, audio). UGC is typically posted by its creator to online platforms, including but not limited to social media, blogs, Wiki™ and the like. One trend related to UGC is personal moment sharing in variable environments (e.g., indoors, outdoors, by the sea) by recording video and audio using a personal mobile device (e.g., smart phone, tablet computer, wearable devices). Most UGC content contains audio artifacts due to consumer hardware limitations and a non-professional recording environment. The traditional way of UGC processing is based on audio signal analysis or artificial intelligence (AI) based noise reduction and enhancement processing. One difficulty in processing UGC is how to treat different sound types in different audio environments while maintain the created objective of the content creator.

### SUMMARY

Embodiments are disclosed for context aware soundscape control.

In some embodiments, an audio processing method comprises: capturing, using a first set of microphones on a mobile device, a first audio signal from an audio scene; capturing, using a second set of microphones on a pair of earbuds, a second audio signal from the audio scene; capturing, using a camera on the mobile device, a video signal from a video scene; generating, with at least one processor, a processed audio signal from the first audio signal and the second audio signal, the processed audio signal generated with adaptive soundscape control based on context information; and combining, with the at least one processor, the processed audio signal and the captured video signal as multimedia output.

In some embodiments, the processed audio signal with adaptive soundscape control is obtained by at least one of mixing the first audio signal and the second audio signal, or selecting one of the first audio signal or the second audio signal based on the context information.

In some embodiments, the context information includes at least one of speech location information, a camera identifier for the camera used for video capture or at least one channel configuration of the first audio signal.

In some embodiments, the speech location information indicates the presence of speech in a plurality regions of the audio scene.

In some embodiments, the plurality of regions include self area, frontal area and side area, a first speech from self area is self-speech of a first speaker wearing the earbuds, a second speech from the frontal area is the speech of a second speaker not wearing the earbuds in the frontal area of the camera used for video capture, and third speech from the side area is the speech of a third speaker to the left or right of the first speaker wearing the earbuds.

In some embodiments, the camera used for video capture is one of a front-facing camera or rear-facing camera.

In some embodiments, the at least one channel configuration of the first audio signal includes at least a microphone layout and an orientation of the mobile device used to capture the first audio signal.

In some embodiments, the at least one channel configuration includes a mono channel configuration and a stereo channel configuration.

In some embodiments, the speech location information is detected using at least one of audio scene analysis or video scene analysis.

In some embodiments, the audio scene analysis comprises at least one of self-external speech segmentaton or external speech direction-of-arrival (DOA) estimation.

In some embodiments, the self-external speech segmentation is implemented using bone conduction measurements from a bone conduction sensor embedded in at least one of the earbuds.

In some embodiments, the external speech DOA estimation takes inputs from the first and second audio signal, and extracts spatial audio features from the inputs.

In some embodiments, the spatial features include at least inter-channel level difference.

In some embodiments, the video scene analysis includes speaker detection and localization.

In some embodiments, the speaker detection is implemented by facial recognition, the speaker localization is implemented by estimating speaker distance from the camera based on a face area provided by the facial recognition and focal length information from the camera used for video signal capture.

In some embodiments, the mixing or selection of the first and second audio signal further comprises a pre-processing step that adjusts one or more aspects of the first and second audio signal.

In some embodiments, the one or more aspects includes at least one of timbre, loudness or dynamic range.

In some embodiment, the method further comprises a post-processing step that adjusts one or more aspects of the mixed or selected audio signal.

In some embodiment, the one or more aspects include adjusting a width of the mixed or selected audio signal by attenuating a side component of the mixed or selected audio signal.

In some embodiments, a system of processing audio, comprises: one or more processors; and a non-transitory computer-readable medium storing instructions that, when executed by the one or more processors, cause the one or more processors to perform any of the preceding methods.

In some embodiments, a non-transitory computer-readable medium storing instructions that, when executed by the one or more processors, cause the one or more processors to perform any of the preceding methods.

Particular embodiments disclosed herein provide one or more of the following advantages. The disclosed context aware soundscape control embodiments can be used for binaural recordings to capture a realistic binaural soundscape while maintaining the creative objective of the content creator.

### DESCRIPTION OF DRAWINGS

In the drawings, specific arrangements or orderings of schematic elements, such as those representing devices, units, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths, as may be needed, to affect the communication.

FIG. 1 illustrates binaural recording using earbuds and a mobile device, according to an embodiment.

FIG. 2A illustrates the capture of audio when the user is holding the mobile device in a front-facing position, according to an embodiment.

FIG. 2B illustrates the capture of audio when the user is holding the mobile device in a rear-facing or “selfie” position, according to an embodiment.

FIG. 3 is a block diagram of a system for context aware soundscape control, according to an embodiment.

FIG. 4 is a flow diagram of a process of context aware soundscape control, according to an embodiment.

FIG. 5 is a block diagram of an example device architecture for implementing the features and processes described in reference to FIGS. 1-4, according to an embodiment.

The same reference symbol used in various drawings indicates like elements.

### DETAILED DESCRIPTION

In the following detailed description, numerous specific details are set forth to provide a thorough understanding of the various described embodiments. It will be apparent to one of ordinary skill in the art that the various described embodiments may be practiced without these specific details. In other instances, well-known methods, procedures, components, and circuits, have not been described in detail so as not to unnecessarily obscure aspects of the embodiments. Several features are described hereafter that can each be used independently of one another or with any combination of other features.

The disclosed context aware audio processing is comprised of the following steps. First, a binaural capture device (e.g., a pair of earbuds) records a multichannel input audio signal (e.g., binaural left (L) and right (R)), and a playback device (e.g., smartphone, tablet computer or other device) that renders the multichannel audio recording through multiple speakers. The recording device and the playback device can be the same device, two connected devices, or two separate devices. The speaker count used for multispeaker rendering is at least three. In some embodiments, the speaker count is three. In other embodiments, the speaker count is four.

The capture device comprises a context detection unit to detect the context of the audio capture, and the audio processing and rendering is guided based on the detected context. In some embodiments, the context detection unit includes a machine learning model (e.g., an audio classifier) that classifies a captured environment into several event types. For each event type, a different audio processing profile is applied to create an appropriate rendering through multiple speakers. In some embodiments, the context detection unit is a scene classifier based on visual information which classifies the environment into several event types. For each event type, a different audio processing profile is applied to create appropriate rendering through multiple speakers. The context detection unit can also be based on combination of visual information, audio information and sensor information.

In some embodiments, the capture device or the playback device comprises at least a noise reduction system, which generates noise-reduced target sound events of interest and residual environment noise. The target sound events of interest are further classified into different event types by an audio classifier. Some examples of target sound events include but are not limited to speech, noise or other sound events. The source types are different in different capture contexts according to the context detection unit.

In some embodiments, the playback device renders the target sound events of interest across multiple speakers by applying a different mix ratio of sound source and environment noise, and by applying different equalization (EQ) and dynamic range control (DRC) according to the classified event type.

In some embodiments, the context could be speech location information, such as the number of people in the scene and their position relative to the capture device. The context detection unit implements speech direction of arrival (DOA) estimation based on audio information. In some embodiments, context can be determined using facial recognition technology based on visual information.

In some embodiments, the context information is mapped to a specific audio processing profile to create an appropriate soundscape. The specific audio processing profile will include a least a specific mixing ratio.

### Nomenclature

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The term “one example embodiment” and “an example embodiment” are to be read as “at least one example embodiment.” The term “another embodiment” is to be read as “at least one other embodiment.” The terms “determined,” “determines,” or “determining” are to be read as obtaining, receiving, computing, calculating, estimating, predicting or deriving. In addition, in the following description and claims, unless defined otherwise, all technical and scientific terms used herein have the same meaning as commonly understood by one of ordinary skills in the art to which this disclosure belongs.

### Example System

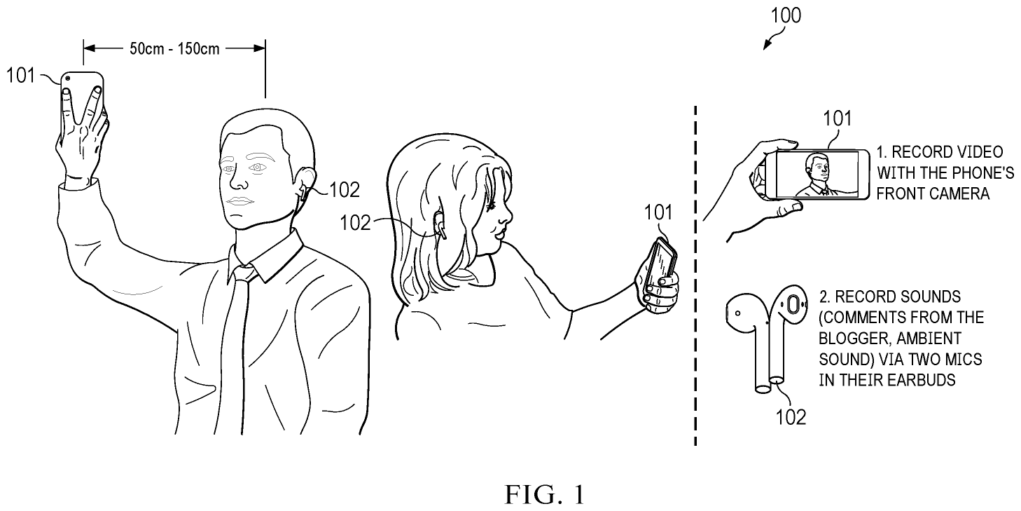

FIG. 1 illustrates binaural recording using earbuds 102 and a mobile device 101, according to an embodiment. System 100 includes a two-step process of recording video with a video camera of mobile device 101 (e.g., a smartphone), and concurrently recording audio associated with the video recording. In an embodiment, the audio recording can be made by, for example, mobile device 101 recording audio signals output by microphones embedded in earbuds 102. The audio signals can include but are not limited to comments spoken by a user and/or ambient sound. If both the left and right microphones are used then a binaural recording can be captured. In some implementations, microphones embedded or attached to mobile device 101 can also be used.

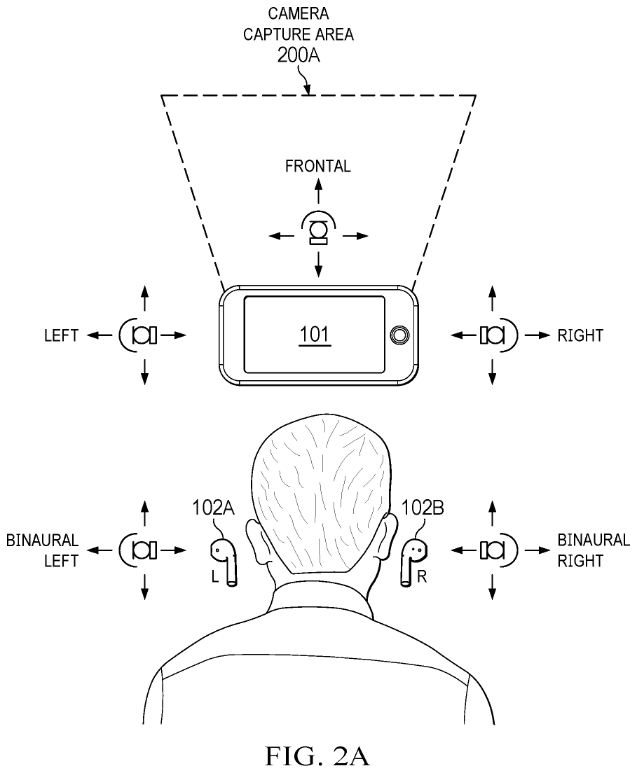

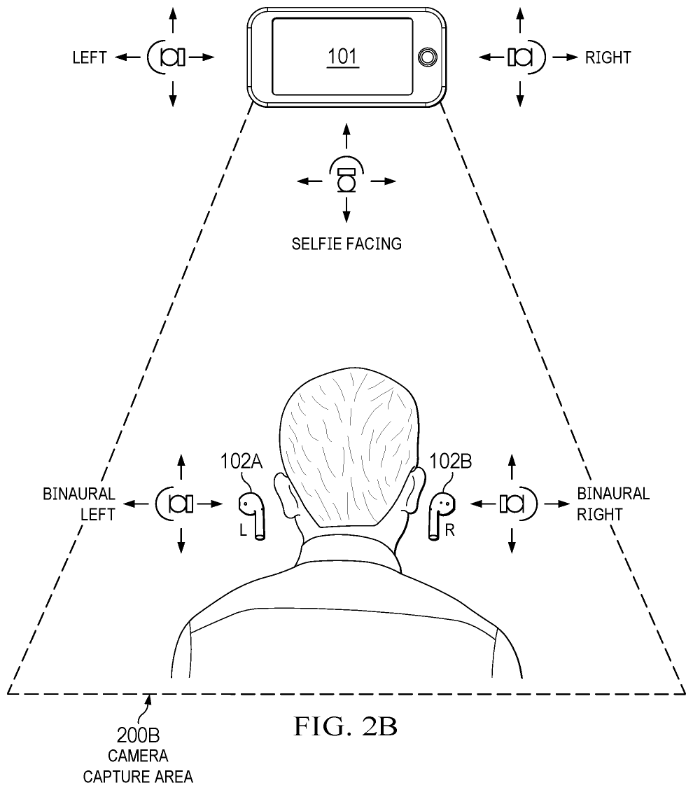

FIG. 2A illustrates the capture of audio when the user is holding mobile device 101 in a front-facing position and using a rear-facing camera, according to an embodiment. In this example, camera capture area 200a is in front of the user. The user is wearing a pair of earbuds 102a, 102b that each include a microphone that captures left/right (binaural) sounds, respectively, which are combined into a binaural recording stream. Microphones 103a-103c embedded in mobile device 101 capture left, frontal and right sounds, respectively, and generate an audio recording stream that is synchronized with the binaural recording stream and rendered on loudspeakers embedded in or coupled to mobile device 101.

FIG. 2B illustrates the capture of audio when the user is holding the mobile device in a front-facing position (“selfie” mode) and using the front-facing camera, according to an embodiment. In this example, camera capture area 200b is behind the user. The user is wearing earbuds 102a, 102b that each include a microphone that captures left/right (binaural) sounds, respectively, which are combined into a binaural recording stream. Microphones 103a-103c embedded in mobile device 101 capture left, frontal and right sound, respectively, and generate an audio recording stream that is synchronized with the binaural recording stream and rendered on loudspeakers coupled to mobile device 101.

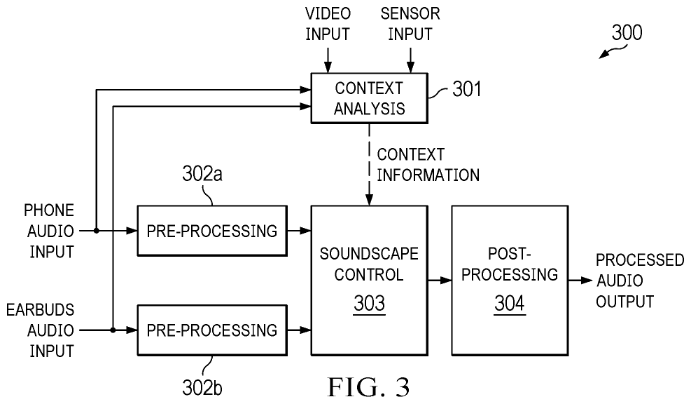

FIG. 3 is a block diagram of a system 300 for context aware soudscape control, according to an embodiment. System 300 includes pre-processing 302a and 302b, soundscape control 303, post-processing 304 and context analysis unit 301.

In some embodiments, context analysis unit 301 takes as input visual information (e.g., digital pictures, video recordings), audio information (e.g., audio recordings) or a combination of visual and audio information. In other embodiments, other sensor data can also be used to determine context alone or in combination with audio and visual information, such as bone conduction sensors on earbuds 102. In some embodiments, the context information can be mapped to a specific audio processing profile for soundscape control. The specific audio processing profile can include a least a specific mixing ratio for mixing a first audio signal captured by a first set of microphones on the mobile device and/or a second signal captured by a second set of microphones on the earbuds, or a selection of the first audio signal or the second audio signal. The mixing or selection are controlled by context analysis unit 301.

### Context Aware Soundscape Control

With multiple microphones onboard the mobile device and earbuds as described in reference to FIGS. 1-3, there could be many ways to combine those microphone inputs to create a binaural soundscape, with different trade-offs, for example between intelligibility and immersiveness. The disclosed context aware soundscape control uses context information to make reasonable estimations of content creator intention and create binaural soundscape accordingly. The specific tradeoffs can be different based on the operating mode of the camera, as well as the microphone configuration on the mobile device.

### A. Microphone on Mobile Device Generates Mono Audio Stream

1. Camera Operated in Normal Mode

In this scenario, the rear-facing camera of the mobile device (e.g., smartphone) is operated by a user wearing earbuds located behind the rear-facing camera, as shown in FIG. 2A, and thus the user, and this their earbud microphones, are located further away from the sound source which can be an object of interest (e.g., an object being recorded by a built in video camera of the mobile device). In this scenario, mixing the audio captured by the mobile device microphones with the audio captured by the earbud microphones can improve the signal-to-noise ratio (SNR) for the sound source in camera capture area 200a. This scenario, however, may also lead to a downgrade in the immersiveness of the audio scene experienced by the user. In such a scenario, context information (e.g., see FIG. 3) can be used to automatically choose an audio capture processing profile to generate an appropriate soundscape in different cases.

In one case, the context information includes speech location information. For example, if a speaker is present in the camera capture area 200a, the user's intent is likely to capture the speech of the speaker, and thus improving the SNR for speech could denigrate the overall immersiveness of the soundscape. On the other hand, if there is no speaker present in camera capture region 200a, the user's intent is likely to capture the landscape (e.g., ambient audio of ocean waves), thus making the overall immersiveness of the soundscape a higher priority to the user.

In some embodiments, the speech location information can be provided by audio scene analysis. For example, the audio scene analysis can include self-external speech segmentation and external speech DOA estimation. In some embodiments, the self-external speech segmentation can be implemented with a bone conduction sensor. In some embodiments, the external speech DOA estimation can take inputs from multiple microphones on the earbuds and the mobile device, extracting features like inter-channel level difference and inter-channel phase difference. With the external speech detected in the camera frontal region, the speaker is assumed to be present in the camera frontal region.

In some embodiments, the speech location information can also be provided by video scene analysis. For example, the video scene analysis can include facial recognition, and estimation of speaker distance based on face area and focal length information. The facial recognition can use one or more machine learning algorithms used in computer vision.

In some embodiments, the speaker distance from the camera is given by:

$$d = \frac{{f}_{0} {h}_{f} {P}_{s}}{{h}_{s} {P}_{i}} , \qquad [ 1 ]$$

where f₀ is focal length in mm (millimeters), h_{f} is the typical height of human face in mm, Pₛ is the height of the image sensor in pixels, hs is the height of image sensor in mm, Pᵢ is the height of recognized face in pixels and d is the distance of the face from the camera in mm.

With the face recognized in the video in the camera capture area 200a, for example within 2 meters in front of the rear-facing camera, the speaker will be assumed present in the camera capture area 200a.

In some embodiments, the speech location information can also be provided by combining the aforementioned audio scene analysis and video scene analysis. For example, the presence of one or more speakers in camera capture area 200a is assumed only when both the audio scene analysis and the video scene analysis suggest the presence of a speaker in camera capture area 200a.

With speakers present in camera capture area 200a, the audio captured by the smartphone is mixed with the binaural audio captured by the earbuds. As given by:

L′=α_{L}S+βL, [2]

R′=α_{R}S+βR, [3]

where L and R are the left and right channels, respectively, of the binaural audio captured by the earbuds, S is the additional audio channel captured by the mobile device, β is a mix ratio of binaural signal L and R and α_{L} and α_{R} are the mix ratios of additional audio channel S.

The mix ratios α_{L} and α_{R} can be the same value, i.e., α_{L}=α_{R}=α, or they can be steered by DOA estimation, for example, using Equations [4] and [5]:

$$\begin{matrix}{α}_{L} = α cos ( θ + \frac{π}{4} ) , & [ 4 ] \\ {α}_{R} = α sin ( θ + \frac{π}{4} ) , & [ 5 ]\end{matrix}$$

where θ is given by the DOA estimation.

In both cases α+β=1, α has a value range of 0.1 to 0.5 and a typical value of 0.3. When speakers are not present in the frontal area, α=0 so the audio is entirely from the earbuds to preserve the immersiveness.

2. Camera Operated in Selfie Mode

In selfie mode, the front-facing camera is used, and the user who is wearing earbuds is located in the camera field of view (FOV) (camera capture area 200b in FIG. 2B). When there are more than one speaker in the FOV, the external speech captured by the microphones may bias the soundscape to one side, since the external speakers usually stand side by side with the user wearing the earbuds. For better audio/video congruence, in some embodiments soundscape width control is introduced. Width control, however, comes at the cost of immersiveness of the overall soundscape. In selfie camera mode, context information can be leveraged to automatically choose an audio capture processing profile that is more suitable for selfie camera mode.

In some embodiments, the context information includes speech location information. If more than one speaker is present in the scene, the intention of the user is most likely to capture the speech of the speakers, and soundscape width control can be used to balance the soundscape. The speech location information can be provided by, for example, video scene analysis. In some implementations, the video scene analysis includes facial recognition, and an estimation of speaker distance based on face area and focal length information.

The facial recognition can use one or more machine learning algorithms used in computer vision. In some embodiments, the speaker distance from the camera is given by:

$$d = \frac{{f}_{0} {h}_{f} {P}_{s}}{{h}_{s} {P}_{i}} , \qquad [ 6 ]$$

where f₀ is focal length in mm (millimeters), h_{f} is the typical height of human face in mm, Pₛ is the height of the image sensor in pixels, hs is the height of image sensor in mm, Pᵢ is the height of recognized face in pixels and d is the distance of the face from the camera in mm. With multiple faces detected and at similar distance from the camera (e.g., 0.5 m when the smartphone is held by hand, or 1.5 m when the smartphone is mounted on a selfie stick), soundscape width control can be applied.

In some embodiments, the speech location information can also be provided by audio scene analysis. In some embodiments, the scene analysis includes self-external speech segmentation and external speech DOA estimation. In some embodiments, the self-external speech segmentation can be implemented with a bone conduction sensor. The external speech DOA estimation can take inputs from multiple microphones on the earbuds and the smartphone and extract features like inter-channel level difference and inter-channel phase difference. When the external speech is detected by the side of the earbud user with a loudness indicative of self-speech due to the close proximity of the user's mouth to the earbud microphones, the additional speaker is assumed to be standing next to the user wearing the earbuds, and thus soundscape width control is applied.

In some embodiments, the soundscape width control is achieved by attenuation of a side component of the binaural audio. First, the input binaural audio is converted to middle-side (M/S) representation by:

M=0.5(L+R), [6]

S=0.5(L−R), [7]

where L and R is the left and right channel of input audio, whereas M and S are the middle and side components, respectively, given by the conversion.

The side channel is attenuated by a factor α, and the processed output audio signal is given by:

L′=M+αS, [8]

R′=M−αS. [9]

For a typical selfie camera mode on mobile devices, the attenuation factor α is in the range of 0.5 to 0.7.

In another example, the soundscape width control is achieved by mixing the audio captured by the mobile device with the binaural audio captured by the earbuds, given by:

L′=αS+βL, [10]

R′=αS+βR. [11]

where α+β=1 and a has a value range of 0.1 to 0.5 and a typical value of 0.3.

### B. Microphone on Mobile Device Generate A-B Stereo Audio Stream

1. Camera Operated in Normal Mode

In normal camera mode, the rear-facing camera of the mobile device is used, and the user wearing earbuds is located behind the camera, and as such, is further away from the object of interest. In this scenario, the A-B stereo captured by a mobile device microphone provides an immersive experience of the soundscape, while keeping audio/visual (A/V) congruence (e.g., consistent perception of speaker locations in audio and video), since the microphones are onboard the same device as the camera. However, when the user is speaking introducing, e.g., the scene as a narrator, the A-B stereo recording will have a narrator track frequently moving around the center, due to the fact that the narrator is oftentimes slightly off-axis to the microphones as he moves the camera around to shoot in different directions. In this example scenario, context information is leveraged to automatically generate an appropriate soundscape in different cases. In one case, the context could be speech location information. In some embodiments, the speech location information can be provided by audio scene analysis. In some embodiments, the scene analysis involves self-external speech segmentation. In some embodiments, the self-external speech segmentation is implemented with a bone conduction sensor.

In self-speech segments, the audio captured by earbuds is mixed with A-B stereo recorded by the mobile device, as given by:

L′=αL_{AB}+βL_{Bud}, [11]

R′=αR_{AB}+/R_{Bud}, [12]

where L′ and R′ are the left and right channels of the mixed audio, L_{AB} and R_{AB} are the left and right channels of the A-B stereo recording, L_{Bud} and R_{Bud} are the left and right channels of the earbud recording, α+β=1 and a has a value in the range of about 0.0 to about 0.3 and a typical value of about 0.1.

2. Camera in Selfie Mode

In selfie mode, the selfie camera is used, and the user is in the scene with opposite direction to the camera. The A-B stereo generated by the mobile phone microphones has better audio and video congruence. However, when there is only one speaker in the selfie camera acting as the narrator, the A-B stereo recording will have a narrator track frequently moving around the center, due to the fact that narrator is oftentimes slightly off-axis to the microphones as he moves the camera around to shoot in different directions. In this example scenario, context awareness is leveraged to automatically choose a suitable audio capture processing profile in different cases. In some embodiments, the context could be speech location information. If more than one speaker is present in the scene, the intention of the user is most likely to capture the speech of the speakers and soundscape width control can be used to balance the soundscape.

In some embodiments, the speech location information can be provided by video scene analysis. In some embodiments, the scene analysis includes facial recognition, and estimation of speaker distance from the camera based on face area and focal length information. The facial recognition can use one or more machine learning algorithms used in computer vision. The speaker distance d from the camera is given by:

$$d = \frac{{f}_{0} {h}_{f} {P}_{s}}{{h}_{s} {P}_{i}} , \qquad [ 13 ]$$

where f₀ is focal length in mm (millimeters), h_{f} is the typical height of human face in mm, Pₛ is the height of the image sensor in pixels, hs is the height of image sensor in mm, Pᵢ is the height of recognized face in pixels and d is the distance of the face from the camera in mm.

With multiple faces detected and at similar distance from the camera (e.g., 0.5 m when the smartphone is held by hand, or 1.5 m when the smartphone is mounted on a selfie stick), the A-B stereo stream is used as the output. If not detected, the binaural audio stream captured by earbuds is used as the output.

In some embodiments, the speech location information can also be provided by audio scene analysis. In one case, the scene analysis includes self-external speech segmentation and external speech DOA estimation. In some embodiments, the self-external speech segmentation can be implemented with a bone conduction sensor. In some embodiments, the external speech DOA estimation can take inputs from multiple microphones on the earbuds and the mobile device, extracting features like inter-channel level difference and inter-channel phase difference. When the external speech is detected by the side of the user with a loudness level indicative of self-speech, an additional speaker is assumed to be present next to the user, and the A-B stereo stream is used as the output. If external speech is not detected, the binaural audio stream captured by the earbud microphones is used as the output.

### Example Process

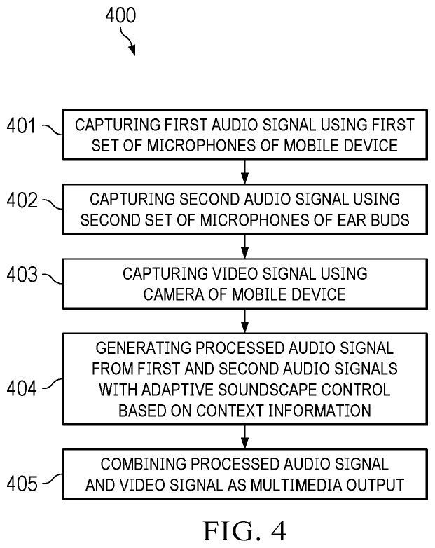

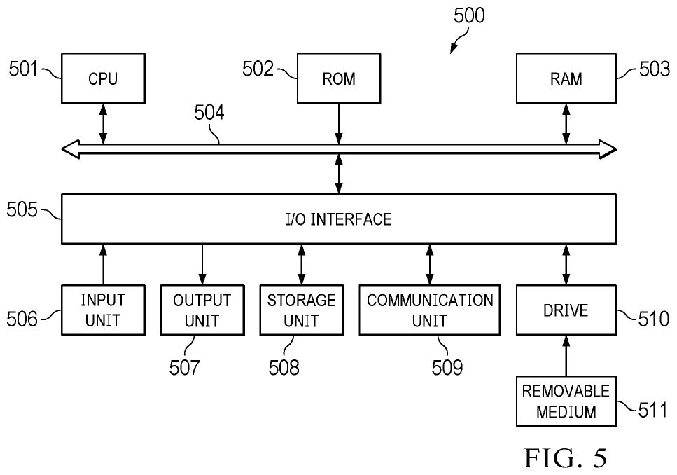

FIG. 4 is a flow diagram of process 400 of context aware soundscape control, according to an embodiment. Process 400 can be implemented using, for example, device architecture 500 described in reference to FIG. 5.

In some embodiments, process 400 comprises: capturing, using a first set of microphones on a mobile device, a first audio signal from an audio scene (401), capturing, using a second set of microphones on a pair of earbuds, a second audio signal from the audio scene (402), capturing, using a camera on the mobile device, a video signal from a video scene (403), generating, with at least one processor, a processed audio signal from the first audio signal and the second audio signal with adaptive soundscape control based on context information (404), and combining the processed audio signal and the captured video signal as multimedia output (405). Each of these steps is described above in reference to FIGS. 1-3.

### Example System Architecture

FIG. 5 shows a block diagram of an example system 500 suitable for implementing example embodiments described in reference to FIGS. 1-10. System 500 includes a central processing unit (CPU) 501 which is capable of performing various processes in accordance with a program stored in, for example, a read only memory (ROM) 502 or a program loaded from, for example, a storage unit 508 to a random access memory (RAM) 503. In the RAM 503, the data required when the CPU 501 performs the various processes is also stored, as required. The CPU 501, the ROM 502 and the RAM 503 are connected to one another via a bus 504. An input/output (I/O) interface 505 is also connected to the bus 504.

The following components are connected to the I/O interface 505: an input unit 506, that may include a keyboard, a mouse, or the like; an output unit 507 that may include a display such as a liquid crystal display (LCD) and one or more speakers; the storage unit 508 including a hard disk, or another suitable storage device; and a communication unit 509 including a network interface card such as a network card (e.g., wired or wireless).

In some embodiments, the input unit 506 includes one or more microphones in different positions (depending on the host device) enabling capture of audio signals in various formats (e.g., mono, stereo, spatial, immersive, and other suitable formats).

In some embodiments, the output unit 507 include systems with various number of speakers. The output unit 507 can render audio signals in various formats (e.g., mono, stereo, immersive, binaural, and other suitable formats).

The communication unit 509 is configured to communicate with other devices (e.g., via a network). A drive 510 is also connected to the I/O interface 505, as required. A removable medium 511, such as a magnetic disk, an optical disk, a magneto-optical disk, a flash drive or another suitable removable medium is mounted on the drive 510, so that a computer program read therefrom is installed into the storage unit 508, as required. A person skilled in the art would understand that although the system 500 is described as including the above-described components, in real applications, it is possible to add, remove, and/or replace some of these components and all these modifications or alteration all fall within the scope of the present disclosure.

In accordance with example embodiments of the present disclosure, the processes described above may be implemented as computer software programs or on a computer-readable storage medium. For example, embodiments of the present disclosure include a computer program product including a computer program tangibly embodied on a machine readable medium, the computer program including program code for performing methods. In such embodiments, the computer program may be downloaded and mounted from the network via the communication unit 709, and/or installed from the removable medium 511, as shown in FIG. 5.

Generally, various example embodiments of the present disclosure may be implemented in hardware or special purpose circuits (e.g., control circuitry), software, logic or any combination thereof. For example, the units discussed above can be executed by control circuitry (e.g., a CPU in combination with other components of FIG. 5), thus, the control circuitry may be performing the actions described in this disclosure. Some aspects may be implemented in hardware, while other aspects may be implemented in firmware or software which may be executed by a controller, microprocessor or other computing device (e.g., control circuitry). While various aspects of the example embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product including a computer program tangibly embodied on a machine readable medium, the computer program containing program codes configured to carry out the methods as described above.

In the context of the disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may be non-transitory and may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present disclosure may be written in any combination of one or more programming languages. These computer program codes may be provided to a processor of a general purpose computer, special purpose computer, or other programmable data processing apparatus that has control circuitry, such that the program codes, when executed by the processor of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server or distributed over one or more remote computers and/or servers.

While this document contains many specific embodiment details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination. Logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1-21. (canceled)

22. An audio processing method, comprising:
capturing (401), using a first set of microphones on a mobile device, a first audio signal from an audio scene;
capturing (402), using a second set of microphones on a pair of earbuds, a second audio signal from the audio scene;
capturing (403), using a camera on the mobile device, a video signal from a video scene;
generating (404), with at least one processor, a processed audio signal from the first audio signal and the second audio signal, the processed audio signal generated with adaptive soundscape control based on context information, wherein the context information is determined based on a combination of the video signal and at least one of the first audio signal and the second audio signal; and
combining (405), with the at least one processor, the processed audio signal and the captured video signal as multimedia output.

23. The method of claim 22, wherein the processed audio signal with adaptive soundscape control is obtained by at least one of mixing the first audio signal and the second audio signal, or selecting one of the first audio signal or the second audio signal based on the context information.

24. The method of claim 22, wherein the context information includes at least one of speech location information, a camera identifier for the camera used for video capture or at least one channel configuration of the first audio signal, wherein the channel configuration includes at least a microphone layout and an orientation of the mobile device used to capture the first audio signal.

25. The method of claim 24, wherein the speech location information indicates the presence of speech in a plurality of regions of the audio scene.

26. The method of claim 25, wherein the plurality of regions include self area, frontal area and side area, a first speech from the self area is a self-speech of a first speaker wearing the earbuds, a second speech from the frontal area is a speech of a second speaker not wearing the earbuds in the frontal area of the camera used for video capture, and a third speech from the side area is a speech of a third speaker to the left or right of the first speaker wearing the earbuds.

27. The method of claim 24, wherein the camera used for video capture is one of a front-facing camera or rear-facing camera.

28. The method of claim 24, wherein the at least one channel configuration includes a mono channel configuration and a stereo channel configuration.

29. The method of claim 24, wherein the speech location information is detected using at least one of audio scene analysis or video scene analysis.

30. The method of claim 29, wherein the audio scene analysis comprises at least one of self-external speech segmentation or external speech direction-of-arrival (DOA) estimation, wherein the self-external speech segmentation is implemented using bone conduction measurements from a bone conduction sensor embedded in at least one of the earbuds and the external speech DOA estimation takes inputs from the first and second audio signal, and extracts spatial audio features from the inputs.

31. The method of claim 30, wherein the spatial audio features include at least inter-channel level difference.

32. The method of claim 29, wherein the video scene analysis includes speaker detection and localization.

33. The method of claim 32, wherein the speaker detection is implemented by facial recognition, the speaker localization is implemented by estimating speaker distance from the camera based on a face area provided by the facial recognition and focal length information from the camera used for video signal capture.

34. The method of claim 23, wherein the mixing or selection of the first and second audio signal further comprises a pre-processing step that adjusts one or more aspects of the first and second audio signal.

35. The method of claim 34, wherein the one or more aspects includes at least one of timbre, loudness or dynamic range.

36. The method of claim 23, further comprising a post-processing step that adjusts one or more aspects of the mixed or selected audio signal.

37. The method of claim 36, wherein the one or more aspects of the mixed or selected audio signal include adjusting a width of the mixed or selected audio signal by attenuating a side channel component of the mixed or selected audio signal.

38. An audio processing system, comprising:
a first set of microphones on a mobile device for capturing a first audio signal from an audio scene;
a second set of microphones on a pair of earbuds for capturing a second audio signal from the audio scene;
a camera on the mobile device for capturing a video signal from a video scene;
at least one processor; and
a non-transitory, computer-readable storage medium storing instructions that, when executed by the at least one processor, cause the one or more processors to perform the operations of claim 22.

39. A non-transitory, computer-readable storage medium storing instructions that, when executed by at least one processor, cause the at least one processor to perform the operations of claim 22.
